(19) United States
(12) Patent Application Publication
(10) Pub. No.: US 2024/0189180 A1
(43) Pub. Date: Jun. 13, 2024

(54) INFLATABLE MASSAGE POOL

(71) Applicant: BESTWAY INFLATABLES & MATERIAL CORP., Shanghai (CN)

(72) Inventor: Xianglin ZENG, Shanghai (CN)

(21) Appl. No.: 18/208,614

(22) Filed: Jun. 12, 2023

(30) Foreign Application Priority Data
Dec. 12, 2022 (CN) 202223334343.0

(51) Int. Cl. A61H 33/00; E04H 4/00; E04H 4/12

(52) U.S. Cl. CPC A61H 33/6094; E04H 4/0025; E04H 4/12; A61H 2033/0058

(57) ABSTRACT

An inflatable massage pool is provided including pool body including a pool wall and a pool bottom. A water holding chamber is defined by a pool wall and a pool bottom. The pool further includes a control box configured to control a massage function. The pool wall includes an air chamber, an accommodating chamber sized to accommodate the control box therein, and a chamber wall separating the air chamber from the accommodating chamber. The chamber wall includes a first opening through which the control box can be placed.

### CROSS-REFERENCE TO RELATED APPLICATION

This application claims priority from Chinese Application CN 202223334343.0, filed Dec. 12, 2022 in China, the disclosure of which is incorporated herein by reference in its entirety.

### BACKGROUND

### 1. Field

Example embodiments relate to above-ground pools, and in particular to an inflatable massage pool.

### 2. Description of Related Art

A portable massage (SPA) pool is a standalone pool holding warm or hot water in which one or more people may be partially immersed. An existing massage pool comprises an inflatable SPA pool with a massage function, the pool including an inflatable pool body, with an inner wall or a bottom portion of the body being provided with a massage nozzle that can spray air or water to achieve a local massage function. A massage control box and the pool body are typically arranged separately, so that the overall product occupies a large area during use and is complicated for installation and inconvenient for operation for a user. In order to provide the user with a more comfortable use experience, improvements are desirable

### SUMMARY

Example embodiments may address at least the above problems and/or disadvantages and other disadvantages not described above. Also, example embodiments are not required to overcome the disadvantages described above, and may not overcome any of the problems described above.

According to an aspect of an example embodiment, an inflatable massage pool comprises: a pool body comprising a pool wall and a pool bottom, wherein a water holding chamber is defined the pool wall and the pool bottom; and a control box configured to control a massage function of the inflatable massage pool, wherein the pool wall comprises: an air chamber, an accommodating chamber sized to accommodate the control box therein, and a chamber wall separating the air chamber from the accommodating chamber, the chamber wall comprising a first opening through which the control box can placed into.

The pool wall may comprise: a top wall, an outer wall, and an inner wall together defining the air chamber therewithin, the chamber wall comprises a chamber surrounding wall connected to the outer wall and the inner wall, and the pool bottom comprises a second opening therein, the second opening in communication with the first opening in the chamber wall.

The chamber wall may further comprise a chamber upper wall connected to the chamber surrounding wall.

The chamber surrounding wall may consist of a single sheet.

The accommodating chamber may comprise a protective wall consisting of a single sheet and connected to the outer wall and the inner wall.

The inflatable massage pool may further comprise an air intake bag providing communication between the pool bottom and the control box.

The control box may comprise a foldable control panel, and the pool wall further comprises an outer wall provided with an opening through which the control panel extends out of the pool wall.

The control box may comprise: a water output end in communication with a water inlet of the pool body, a water intake end in communication with a water outlet of the pool body, a first air supply end in communication with the air chamber, and a second air supply end in communication with an air passage between the pool bottom and the control box.

The water output end may be sealed to the water inlet via a first intermediate member, and the water intake end may be sealed to the water outlet via a second intermediate member.

Each of the first intermediate member and the second intermediate member may be fixedly connected to the pool body.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a schematic external view of an inflatable massage pool according to an example embodiment;

FIG. 2 is a schematic view of the inflatable massage pool of FIG. 1 from another perspective;

FIG. 3 is a schematic exploded view of the inflatable massage pool of FIG. 1;

FIG. 4A is a schematic plan view of a sheet that forms a chamber upper wall;

FIG. 4B is a schematic plan view of a sheet that forms a chamber surrounding wall;

FIG. 4C is a schematic exploded view of the chamber upper wall and the chamber surrounding wall;

FIG. 5A is a schematic plan view of a sheet that forms a protective wall;

FIG. 5B is a schematic view of the protective wall;

FIG. 6 is a schematic view of a control box;

FIG. 7 is a schematic exploded view of fittings of a water intake end and a water output end of the control box;

FIG. 8 is a schematic cross-sectional view of the control box, and shows a schematic exploded view of the fitting of the water intake end; and

FIG. 9 is a schematic enlarged view of part A in FIG. 8.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

The expression “inner” herein refers to a direction toward the water holding chamber of the pool, and “outer” refers to a direction toward the exterior of the whole pool. The term of “air” refers to air flow, etc., that can be introduced from the outside atmosphere or by an apparatus, and “fluid” refers to liquid flow, such as water flow.

It should be appreciated that an existing massage pool has a control box disposed outside a pool body, and thus occupies a large space, is inconvenient for a user to store and use, and is inconvenient for the user to operate massage and other functions during use.

According to one or more example embodiments, the control box is integrated with the pool body. Based on this concept, an inflatable massage pool having an integrally disposed control box may be provided, in which a chamber is formed in a pool wall of a pool body to accommodate the control box, so that the product has reduced overall occupied space and improved appearance, and provides convenient control and operation for a user.

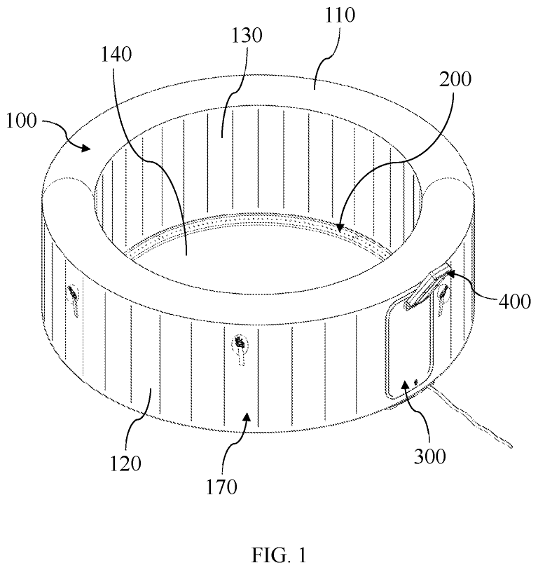

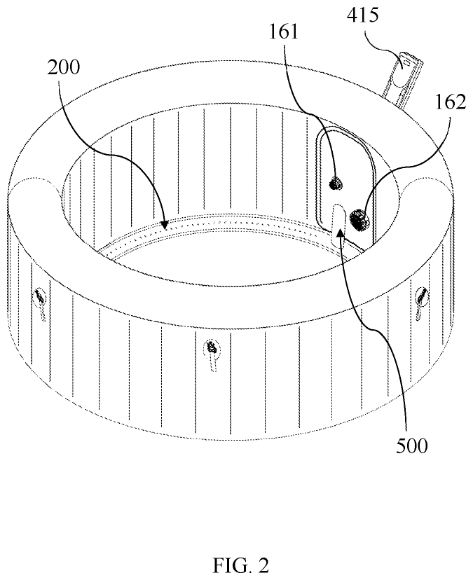

An example embodiment of an inflatable massage pool is shown in conjunction with FIGS. 1 and 2. The inflatable massage pool comprises a pool body 100, the pool body 100 comprising a water holding chamber defined by a pool wall 170 and a pool bottom 140. The pool wall 170 is formed by a top wall 110, an outer wall 120 and an inner wall 130 which are disposed in an enclosing manner, and forms an air chamber with the pool bottom 140, and a plurality of tensioning members 150 are provided in the air chamber to provide support and structural strength.

Specifically, a top portion of the outer wall 120 and a top portion of the inner wall 130 are welded to the top wall 110, and a bottom portion of the outer wall 120 and a bottom portion of the inner wall 130 are welded to the pool bottom 140 to form the air chamber of the pool wall 170. The plurality of tensioning members 150 are arranged at fixed intervals within the air chamber of the pool wall, and the opposite ends of each tensioning member 150 are welded to the outer wall 120 and the inner wall 130, respectively.

In addition, the pool bottom 140 is provided with an air passage 200 to provide a massage function. The control box 400 is arranged in an accommodating chamber 300 provided in the pool wall 170 and is configured to at least control the massage function of the inflatable massage pool, for example, including but not limited to controlling fluid to enter or exit the water holding chamber and/or controlling air to enter the air chamber and the air passage.

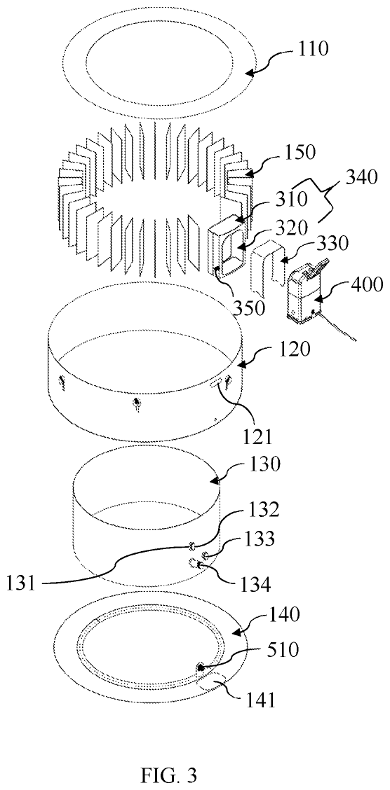

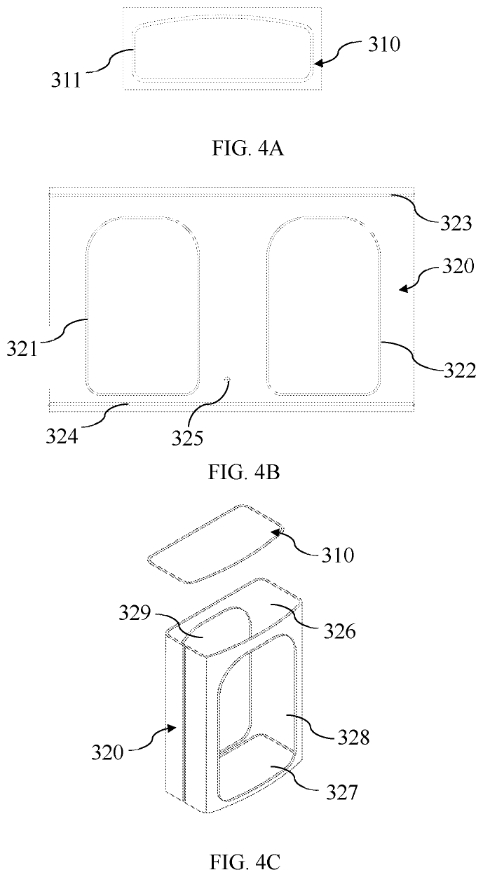

In some example embodiments, the accommodating chamber 300 is separated from the air chamber by a chamber wall 340. Alternatively, the chamber wall 340 is made of a weldable material such as a polyvinyl chloride (PVC) material or a PVC composite material, and is connected to the pool body by welding to form an integrated structure. As shown in FIGS. 3 to 4C, in some example embodiments, the chamber wall 340 comprises a chamber surrounding wall 320 that is formed by a single sheet disposed in an enclosing manner. FIG. 4B shows the chamber surrounding wall 320 in a deployed state, for example, a sheet of a rectangular PVC material or a PVC composite material, with two short sides of the rectangular sheet being connected to each other in an enclosing manner to form the chamber surrounding wall 320. Moreover, the chamber surrounding wall 320 is connected to both the outer wall 120 and the inner wall 130 of the pool body, respectively, along an outer wall welding line 321 and an inner wall welding line 322. In addition, a low portion of the chamber surrounding wall 320 is provided with a bottom wall welding line 324 connected to the pool bottom 140 and is then connected to the pool bottom 140 in a sealing manner so as to form a first opening 327 through which the control box 400 can be put into the accommodating chamber 300, and the pool bottom 140 is provided with a second opening 141 corresponding to the first opening 327, as shown in FIG. 3.

In some example embodiments, the chamber surrounding wall 320 is cut along the outer wall welding line 321 and the inner wall welding line 322 so as to form a third opening 328 and a fourth opening 329 in the chamber surrounding wall 320.

In some example embodiments, a top opening 326 of the chamber surrounding wall 320 that is disposed in an enclosing manner can be connected to the top wall 110 of the pool body along the upper wall welding line 323 so as to close the opening 326. In some example embodiments, the opening 326 can be connected to the chamber upper wall 310 along the upper wall welding line 323, and the chamber upper wall 310 is made of a weldable material such as a PVC material or a PVC composite material and is correspondingly provided with a surrounding wall welding line 311. In this way, the chamber upper wall 310 and the chamber surrounding wall 320 together define the accommodating chamber 300, and the control box 400 is adapted to enter the accommodating chamber 300 through the second opening 141 in the pool bottom 140 of the pool body and is then integrated with the pool body.

As can be seen from FIGS. 3 and 4B, the chamber surrounding wall 320 is provided with an air supply port 325, and then a first air supply end 414 of the control box 400 can be in communication with the air chamber of the pool body by means of an air supply pipe 350.

In some example embodiments, control box 400 may be provided with a foldable control panel 415, which is convenient for the user's operation of functions, such as water filling or massage, of the control box during use, and the pool body is provided with an opening through which the control panel 415 extends out of the pool wall. In the illustrated example embodiment, the outer wall 120 is provided with a fifth opening 121, and the control panel 415 passes through the third opening 328 in the chamber surrounding wall 320 and the fifth opening 121 in the outer wall 120 and then extends out of the pool wall. In some embodiments, the opening through which the control panel extends out may also be provided in the chamber upper wall 310 and the top wall 110.

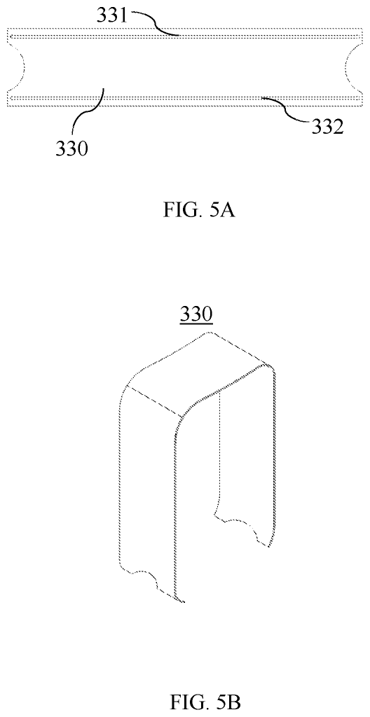

In some example embodiments, the accommodating chamber 300 may be further internally provided with a protective wall 330 that matches the contour of the chamber wall 340 so as to prevent air leakage from the pool body caused by friction between the chamber wall 340 and the control box 400. Alternatively, the protective wall is made of a weldable material such as PVC material or PVC composite material, and is connected to the pool body by welding so as to form an integrated structure. In conjunction with FIGS. 3, 5A and 5B, the protective wall 330 may be formed by a single sheet and connected to both the outer wall 120 and the inner wall 130 of the pool body. FIG. 5A shows the protective wall 330 in the deployed state, in which the protective wall 330 can be connected to the inner wall 130 and the outer wall 120 along an inner welding line 331 and an outer welding line 332, and FIG. 5B shows the shape of the protective wall 330 when welded to the pool body.

It should be understood that the size and shape of the accommodating chamber defined by the chamber wall and the size and shape of the protective wall shown in the example figures match the outer contour of the control box, and the sizes and shapes of the control box and the accommodating chamber can be changed accordingly depending on different needs.

As shown in FIGS. 2, 3 and 6, the inner wall 130 of the pool body is provided with one or more openings through which a pipeline passes, and the example of FIG. 3 shows three openings, one of which is marked with 131. A water intake assembly 161 is connected to a water output end 411 of the control box 400 through an opening in the inner wall. A water output assembly 162 is connected to a water intake end 412 of the control box 400 through another opening in the inner wall. The inner wall 130 is tightly clamped between the water intake assembly 161 and/or the water output assembly 162 and the water output end 411 and/or the water intake end 412 of the control box 400 so as to achieve sealing. In order to enhance the sealing effect, a sealing member can be provided on the water intake assembly 161 and/or the water output end 411 of the control box 400, and a sealing member can be provided on the water output assembly 162 and/or the water intake end 412 of the control box 400.

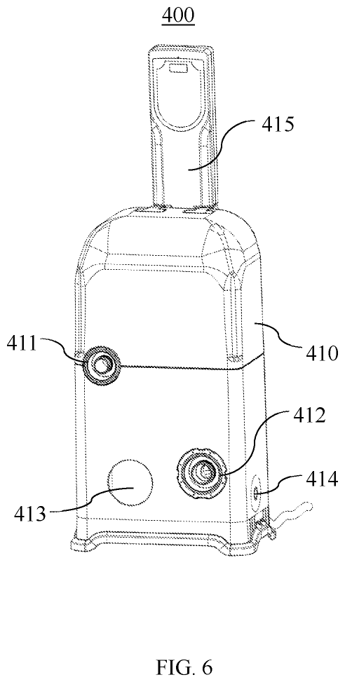

In some example embodiments, intermediate members are fixedly welded at the opening of the inner wall 130. In conjunction with the example embodiment shown in FIG. 6, the water intake assembly 161 and the water output assembly 162 are connected to the water output end 411 and the water intake end 412 of the control box 400, respectively, by means of a water intake intermediate member 132 and a water output intermediate member 133, so as to achieve filling and drainage of the water holding chamber. The control box 400 further comprises a first air supply end 414 in communication with the air chamber for inflating the air chamber, and a second air supply end 413 in communication with the air passage 200. The second air supply end 413 is in communication with the air passage 200 via an air intake bag 500 and a corresponding air intake assembly 510 and via another opening on the inner wall 130 and a corresponding air delivery pipe 134, such that the air is sprayed from through holes in the air passage to form wave-making bubbles, providing a massage effect to the user's soles.

It should be understood that, in the example illustrated embodiment, the control box 400 integrates the functions of inflation, air supply, and water filling and drainage. In some example embodiments, these functions can also be achieved by different control pumps, that is, based on the concept, if the spatial and structural layout allows, more than one control pump can be arranged in the accommodating chamber to respectively achieve one or more of the functions described above or other functions such as heating. In some example embodiments, more than one accommodating chamber may be provided to respectively hold control pumps that achieve different functions.

In the example illustrated embodiment, the air passage 200 is shown in the shape of a circular ring. However, this is not intended to be a limitation, and depending on different needs, the air passage may be in the shape of a closed ring, an open ring, a four-sided ring or any other polygonal ring, or any other suitable form for providing users with a relaxing massage in the pool. Similarly, the inflatable massage pool is shown as an example in a circular shape, but other shapes such as a rectangular shape or other polygonal shapes are not excluded.

Alternatively, one or more of the pool body, the air passage and the air intake bag are made of a weldable material such as a PVC material or a PVC composite material, the pool wall can be connected to the pool bottom by means of hot-melt welding, etc. to form the pool body, and the air passage can be formed at the pool bottom.

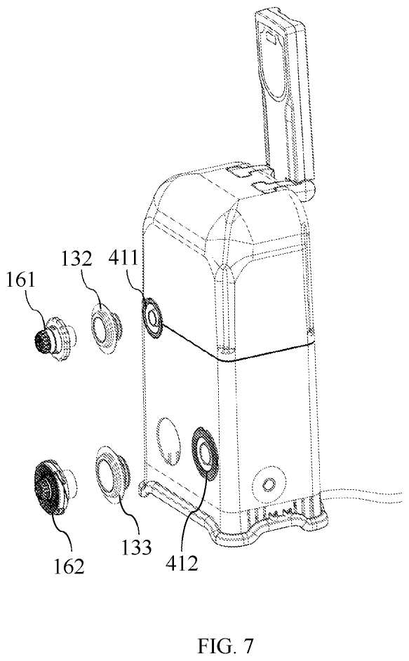

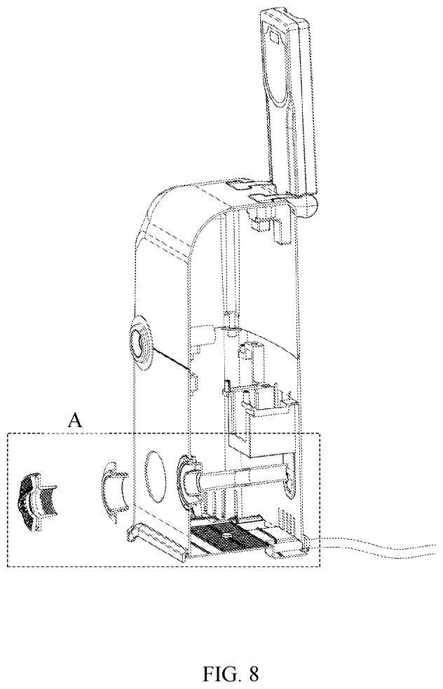

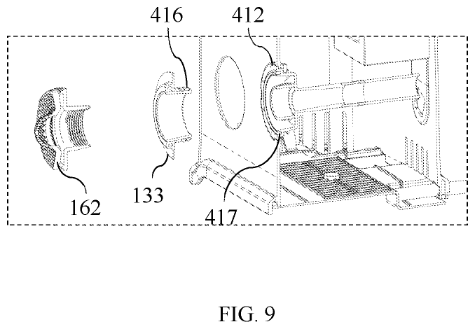

FIGS. 7 to 9 show the fittings of the water intake end and the water output end of the control box 400. As described above, the water intake assembly 161 and the water output assembly 162 are connected to the water output end 411 and the water intake end 412 of the control box 400, respectively, through the water intake intermediate member 132 and the water output intermediate member 133, the water intake intermediate member 132 and the water output intermediate member 133 being welded to the inner wall 130 of the pool body, and the water intake assembly 161 and the water output assembly 162 being connected to the water output end 411 and the water intake end 412 of the control box 400 by screw threads, respectively, through the water intake intermediate member 132 and the water output intermediate member 133. In FIG. 9, taking the water output assembly 162 and the water intake end 412 as examples, the water output intermediate member 133 is provided with a sealing ring 416 to prevent water leakage at the connection. Advantageously, the water intake end 412 may also be provided with a sealing ring 417 to further prevent water leakage.

In the design described herein, the control box is disposed in the pool body to form an integrated structure, so that the product is aesthetically pleasing in overall appearance, occupies small space, and is convenient for the user to operate; and the control box is separated from the air chamber of the pool body in a sealing manner, achieving safe and reliable use.

It should be understood that the example embodiments as shown in the figures only show the alternative shapes, sizes and arrangements of the alternative components of the inflatable massage pool according to the present disclosure, which are merely illustrative but not restrictive, and other shapes, sizes and arrangements may be used. The components and features described herein may be made of multiple materials including, but not limited to, polymers exemplified above and other suitable materials, such as rubber, foam, metal and coated fabric, or combinations thereof well known to those skilled in the art.

The technical contents and technical features are disclosed above. However, it can be understood that those skilled in the art would have made various variations and improvements to the concepts disclosed above under the creative idea, and all the variations and improvements fall within the scope of protection. The descriptions of the above embodiments are illustrative but not restrictive, and the scope of protection is determined by the claims.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. An inflatable massage pool comprising:
a pool body comprising a pool wall and a pool bottom, wherein a water holding chamber is defined by the pool wall and the pool bottom; and
a control box configured to control a massage function of the inflatable massage pool,
wherein the pool wall comprises:
an air chamber,
an accommodating chamber sized to accommodate the control box therein, and
a chamber wall separating the air chamber from the accommodating chamber, the chamber wall comprising a first opening through which the control box can placed into.

2. The inflatable massage pool according to claim 1, wherein:
the pool wall comprises: a top wall, an outer wall, and an inner wall together defining the air chamber therewithin,
the chamber wall comprises a chamber surrounding wall connected to the outer wall and the inner wall, and
the pool bottom comprises a second opening therein, the second opening in communication with the first opening in the chamber wall.

3. The inflatable massage pool according to claim 2, wherein the chamber wall further comprises a chamber upper wall connected to the chamber surrounding wall.

4. The inflatable massage pool according to claim 2, wherein the chamber surrounding wall consists of a single sheet.

5. The inflatable massage pool according to claim 3, wherein the accommodating chamber comprises a protective wall consisting of a single sheet and connected to the outer wall and the inner wall.

6. The inflatable massage pool according to claim 1, further comprising an air intake bag providing communication between the pool bottom and the control box.

7. The inflatable massage pool according to claim 1, wherein:
the control box comprises a foldable control panel, and
the pool wall further comprises an outer wall provided with an opening through which the control panel extends out of the pool wall.

8. The inflatable massage pool according to claim 7, wherein the control box comprises:
a water output end in communication with a water inlet of the pool body,
a water intake end in communication with a water outlet of the pool body,
a first air supply end in communication with the air chamber, and
a second air supply end in communication with an air passage between the pool bottom and the control box.

9. The inflatable massage pool according to claim 8, wherein:
the water output end is sealed to the water inlet via a first intermediate member, and
the water intake end is sealed to the water outlet via a second intermediate member.

10. The inflatable massage pool according to claim 9, wherein each of the first intermediate member and the second intermediate member is fixedly connected to the pool body.
